(19) United States
(12) Patent Application Publication
(10) Pub. No.: US 2003/0025284 A1
(43) Pub. Date: Feb. 6, 2003

(54) Sliding attachment for shopping carts

(75) Inventors: Terrence Roy Edwards, Wasaga Beach (CA); Donald James Maclam, Toronto (CA)

Correspondence Address: Baker McLachlen, P.O. Box 2780, Station D, Ottawa, ON, K1P 5W8, CA

(73) Assignee: Donald James Maclam

(21) Appl. No.: 09/917,640

(22) Filed: Jul. 31, 2001

(51) Int. Cl. B62K 13/00

(52) U.S. Cl. 280/7.12; 280/47.18

(57) ABSTRACT

A readily removable attachment for a multiple-wheeled conveyance, such as a shopping cart, comprises a flexible sheet having a mounting edge, a substantially smooth first surface designed for contact with the ground, a second wheel-supporting surface adapted to support at least one axially-connected pair of wheels of the conveyance, and a mounting means for releasably securing the flexible sheet at the mounting edge to the conveyance. When not in use, the flexible sheet can be stored by being releasably secured in a non-operational position to the outside of the conveyance, without releasing the mounting means.

### FIELD OF THE INVENTION

This invention relates to attachments for multiple-wheeled conveyances, to facilitate manual operation over soft substances such as snow, mud or sand.

### BACKGROUND TO THE INVENTION

Small manually operated conveyances such as shopping carts and wagons are well known. Although there is a wide variety of designs, such carts are typically lightweight, particularly if they are designed to be folded into a compact form for storage when empty. To keep the weight and size to a minimum, the carts typically have one or two pairs of wheels which are generally close to the minimum size and simplest materials, to reduce costs of construction, while being capable of bearing the gross weight when the cart is loaded to its expected maximum. The advantages of the typical designs are that the cart or wagon can be readily folded and lifted by an average user, and readily used with ease in a variety of indoor or outdoor situations, over surfaces which are firm and reasonably smooth.

However, a significant disadvantage of the typical construction is that on soft surfaces, such as snow, mud or sand, the relatively high pressure over the small ground contacting surface area of the wheels, even where the conveyance is provided with four wheels, results in the wheels readily sinking until becoming buried to the axles and thus stuck. Although the problem can be partly alleviated by pulling the conveyance rather than pushing it, many users for a variety of reasons are physically unable to pull a conveyance effectively in difficult conditions, and pulling is often ineffective over the more difficult surfaces such as deeper snow or mud. The problem is increased where the user wishes to operate the conveyance over a series of different surfaces, such as wet snow, packed snow or ice, partly frozen mud, and loose gravel. In winter conditions, such combinations of surfaces can readily be found in series within a short distance, for example from a store through a parking lot, across a sidewalk and on pathways into a residence.

The possibility of providing attachments for small conveyances which can be attached to individual wheels of shopping carts to provide a smooth sliding surface is known, and shown for example in Canadian Patent No. 1,192,236, and U.S. Pat. Nos. 4,040,638, 4,163,564, 4,251,085, 4,320,904, and 4,498,688, but the attachments shown would not increase the ground contact surface area sufficiently to enable effective pushing or pulling of the conveyance in the more difficult or mixed conditions often encountered, for example in northern winters. In addition, U.S. Pat. Nos. 3,851,891 and 4,191,391 show attachments which provide a smooth sliding surface under a pair of wheels, but which require tools and complex parts for attachment to the conveyance, would clearly add considerably to the weight of the conveyance, and would not be readily removable for cleaning or storage.

### SUMMARY OF THE INVENTION

The invention therefore provides a readily removable attachment for a multiple-wheeled conveyance, comprising a flexible sheet having a mounting edge, a substantially smooth first surface designed for contact with the ground, a second wheel-supporting surface adapted to support at least one axially connected pair of wheels of the conveyance, and a mounting means for releasably securing the flexible sheet at the mounting edge to the conveyance. The size and place of attachment of the sheet can be varied for use for conveyances having a variety of configurations of wheels, and to enable operation of the conveyance by pushing or pulling.

The attachment is simple to install without requiring a high level of manual dexterity, so that installation or removal is feasible even outside during winter by a user wearing gloves. The attachment is highly effective in a variety of adverse operational conditions, enabling the pulling of the conveyance even by users who would otherwise find it extremely difficult or impossible. The attachment is also simple to remove for cleaning or storage, and compact. In addition, instead of removal from the conveyance, the flexible sheet can also, by the use of a simple secondary securing means, be stored on the exterior of the conveyance in a non-operational position, in such a manner as to minimize the deposit of snow, sand or other unwanted material onto the contents of the conveyance from the surface of the sheet which has been in contact with the ground.

### BRIEF DESCRIPTION OF THE DRAWINGS

The invention will now be described by way of example and reference to the accompanying drawings in which:

FIG. 1 is a top view of a flexible sheet of the invention;

FIG. 2 is a sectional view of the flexible sheet of FIG. 1, taken along the lines 2-2 in FIG. 1;

FIGS. 3A and 3B are schematic side views of a two-wheeled conveyance respectively showing a first embodiment of the flexible sheet in a prepared-for-use and an in-use position; and

FIGS. 4A and 4B are schematic side views of a four-wheeled conveyance respectively showing a second embodiment of the flexible sheet in a prepared-for-use and an in-use position.

### DETAILED DESCRIPTION OF THE PREFERRED EMBODIMENT

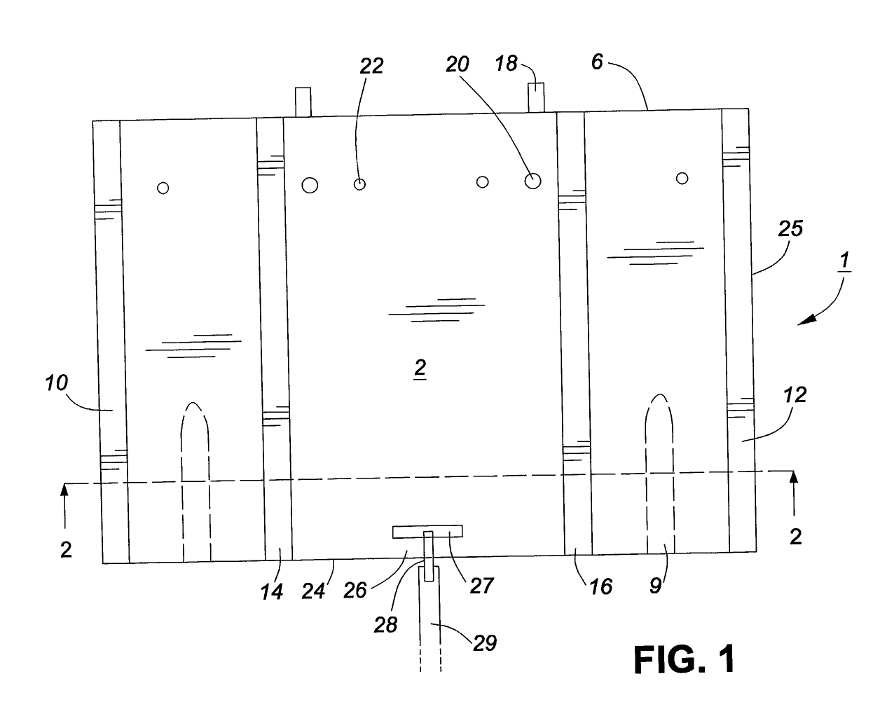

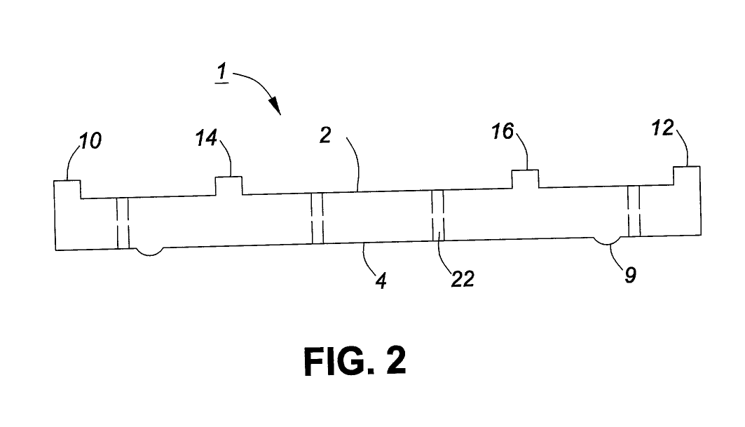

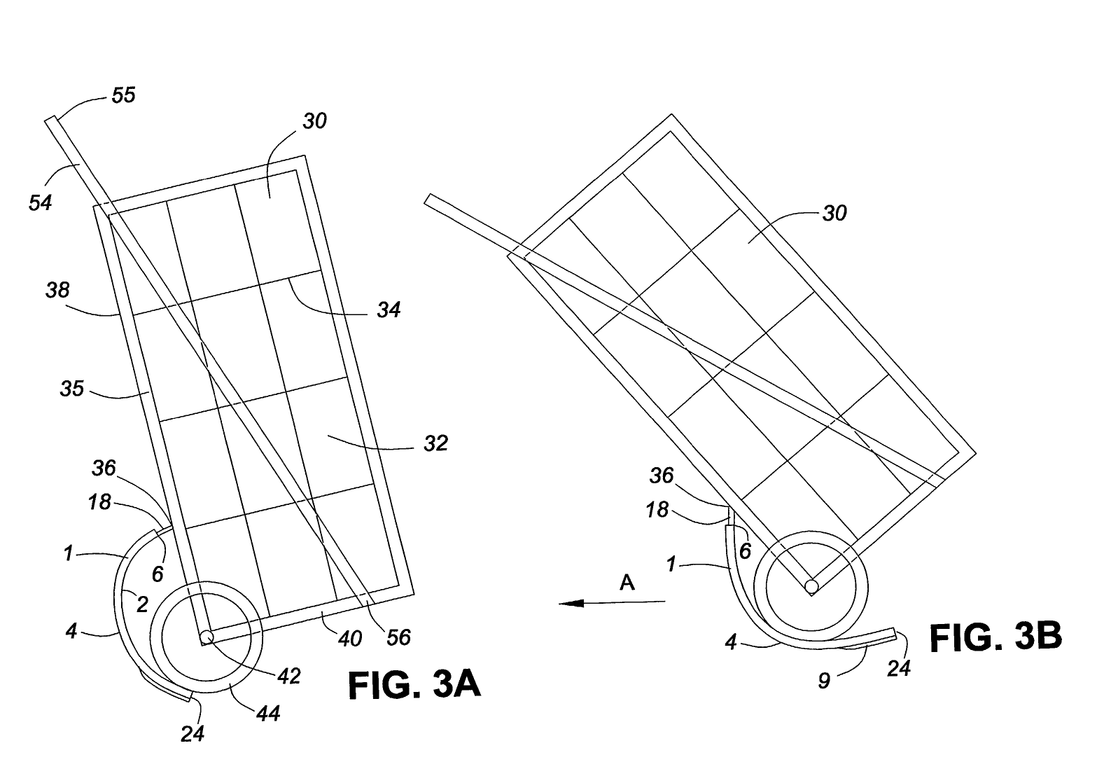

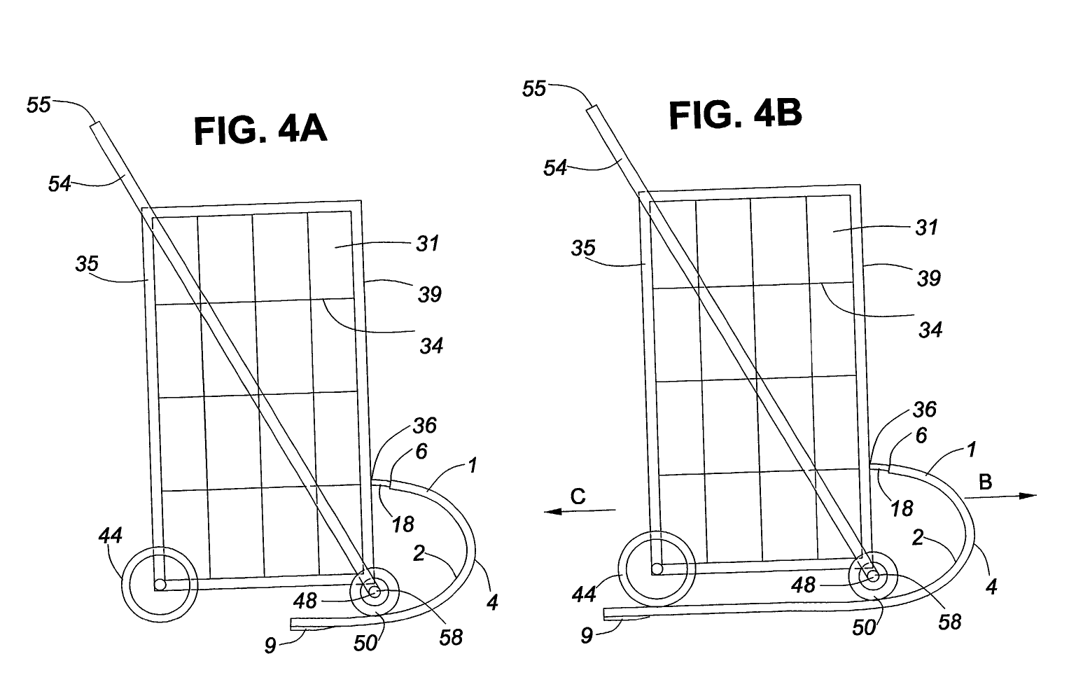

Referring to FIGS. 1 and 2, a flexible sheet 1 comprises an upper wheel supporting surface 2 and a lower surface 4, which is substantially smooth for contact with a surface over which the sheet is intended to slide when in an operational position. A mounting edge 6 is provided with a suitable mounting means 18 at one or more locations along the edge 6. Such means can comprise any simple but readily securable fastening method, such as a hook, clip, or buckle, or one or more strips of hook and loop fastener. The selection of a suitable mounting means 18 will depend on factors including the material of manufacture of the flexible sheet 1, and the nature of the conveyance for which the sheet 1 is intended to be used. For a conveyance such as a shopping cart 30 or 31 (shown in FIGS. 3 and 4) constructed of open weave metal wires forming a wire framework 34, suitable mounting means include a clip, or a single strip comprising sections of hook and loop fastener attached securely to the flexible sheet 1 and of a suitable length to enable it to be threaded around a horizontal section of the wires 34, and secured back on itself, or a first strip of one type can be used, securable to a second strip of the opposing type. Depending on the material of construction of the flexible sheet 1, a hook or clip 18 can be attached close to the mounting edge 6 by rivets 20. In addition, for increased stability, additional attachment means can be used, for example by a symmetrically disposed pair of hooks or clips 18, or one or more holes 22 can be provided at or near the mounting edge 6 to provide for alternative mounting means.

To achieve greater durability, the side edges 25 of the flexible sheet 1 are preferably reinforced by guide ribs 10 and 12 attached to, or integrally constructed with, the flexible sheet 1, and entirely or substantially on the upper wheel-supporting surface 2. The guide ribs 10 and 12 also provide a lateral guide to the wheels of the conveyance, restraining slippage of the wheels off the sides of the flexible sheet 1. An additional pair of inner guide ribs 14 and 16, substantially parallel to guide ribs 10 and 12, and mounted on, or integrally constructed with, the flexible sheet 1 on its upper wheel-supporting surface 2, can provide a guide or restraint to wheels on a narrower base, or function as an additional guide or restraint to the inside of the wheels on a wider base. The flexible sheet 1 can be constructed of a suitable material to enable the sides to be trimmed beyond the inner guide ribs 14 and 16, to reduce the width of the flexible sheet 1 to the operational width of the conveyance 30, provided that the wheel base is less than the spacing between inner guide ribs 14 and 16.

As a further option, either or both pairs of guide ribs 10 and 12, or 14 and 16, can comprise a series of short segments (not shown) aligned in the direction parallel to the side edges 25, which would advantageously reduce the volume of material required for the construction, while allowing for increased flexibility of the flexible sheet 1 yet maintaining the restraining or guiding function of the ribs 10 and 12 or 14 and 16.

At a free edge 24, opposite to the mounting edge 6 of the flexible sheet 1, the flexible sheet 1 can be secured in a non-operational position, when not needed. For example, a secondary securing means such as a clip 28, attached to the free end of a strap means 29 can be releasably engaged to a slot 27 provided at a mount point 26, the other end of the strap means being attached at a suitable location on the conveyance body 32, such as a substantially central point 55 on the handle 54, or at one or more locations 38 at a horizontal portion of the wire framework 34 of cart 30 (FIG. 3A).

Alternatively, a secondary securing means such as a strap means 29 can be attached at the mount point 26, for releasable attachment at a suitable location 38 on the wire framework 32. However, it is generally preferable to have the strap means attached to the cart 30, so that the strap itself is not dragged through the loose ground surface materials such as snow, mud or sand, thus becoming unpleasant or difficult to handle when being used to secure the flexible sheet 1 into the non-operational position; and so that the free end of the strap does not become entangled in the wheels or any obstacles on the ground.

As a further alternative, for example for conveyances where there is no convenient point on the back of the conveyance body 32 to which the secondary securing means such as a clip (not shown) or a strap means can be attached, or for additional security, for example for wider conveyances, the secondary securing means such as a strap (not shown), having a clip at its free end, can be placed at a preselected location along one or both side edges 25 of the flexible sheet 1, so as to be securable to a vertical portion such as corner post 35 of the framework 34 of the cart 30 (FIG. 3A).

As a still further alternative, at either or both ends of the strap means 29, securing can be achieved by the use of a combination of suitably predetermined lengths of hook and loop fastener, the end or ends being threaded through the appropriate location or locations, being either slot 27, securing location 38 on the wire framework 34, or at central point 55 on the handle 54, and thereafter secured back to the strap means 29.

The lower surface 4 of the flexible sheet 1 is substantially smooth, for optimum sliding ability over soft surfaces such as snow, mud or sand. However, for additional durability, the lower surface 4 can be provided with partial reinforcement, such as runners 9, preferably in the region of and substantially perpendicular to the edge opposite to the mounting edge 6, shown in FIG. 1 as free edge 24. A suitable configuration is selected for the runners 9 in order to increase durability without unduly reducing the contact surface area of the lower surface 4, or adversely affecting flexibility. Where the flexible sheet 1 is constructed of a molded material, preferably the runners 9 are integrally constructed with the sheet in the molding process, and of decreasing thickness in the direction of the mounting edge 6. The configuration of the runners 9 can be varied, for example by providing them with a substantially rectangular cross-section, which can provide additional lateral stability for the flexible sheet 1 if desired.

As discussed below, the flexible sheet is preferably constructed from a durable material having a low coefficient of friction, with sufficient flexibility to be readily engageable by the pairs of wheels 44 or 50 (FIGS. 3A, 4A) yet of a suitable rigidity and thickness so as to be not significantly deformable under the gross weight of the cart 30 or 31 (FIGS. 3A, 4A) when loaded, in order to maintain the maximum contact area between the lower surface 4 and the soft surface over which the sheet is intended to slide. However, the material should be sufficiently flexible, even when cold, in all directions to ensure that it slides over, rather than becoming stuck on, any occasional hard material or object which may be encountered, such as stones or lumps of ice. The material should be relatively light in weight so that it does not adversely affect the balance of the conveyance in the non-operational position, or significantly reduce the safe maximum load which can be carried within the conveyance. However, at the same time it is desirable to use a material which does not have an excessive tendency to curl, yet without the adverse consequences of requiring an undue or unwieldy thickness. Suitable materials include molded or extruded polypropylene or high-density polyethylene, or hardened polyethylene.

As a further alternative, the flexible sheet 1 can be constructed as a combination of several interconnectible parts, for example by providing for the guide ribs to be manufactured separately and secured to the sheet by any suitable method, or molded in during manufacture. For example, separate parts can be connected by manual squeezing and snapping or clipping into place, thus facilitating further possible variations of dimensions or configurations. In some situations, the advantages will outweigh the factor that some assembly would be required by the consumer, and by maintaining the simplicity of the design, it can be ensured that any such assembly tasks would not be extensive or complex.

Referring to FIGS. 3A and 3B, a two-wheeled utility cart 30 has a base 40, a vertical framework having corner posts 35, to which are attached a wire framework 34. A single axle 42 connects a pair of wheels 44. A handle 54, preferably having an inverted U-shape and being of unitary construction, for pushing or pulling the cart 30 is attached at its ends at suitable locations 56 along the base 40.

The flexible sheet 1 is shown in an operational position in FIG. 3B, secured at its mounting edge 6 by mounting means 18 to a suitable horizontal point 36 on the wire framework 34 at the back of the cart 30. The upper wheel supporting surface 2 is adjacent to the wheels 44.

To commence movement of the cart 30, the user, standing at the back of the cart 30 and holding the handle 54, tips the cart so that it rotates about the axle 42 towards the user, and pulls it gently. This results in the engagement of the free edge 24 as it passes under the wheels 44. The user can then tip the cart 30 to the desired angle, such as shown in FIG. 3B, depending on the particular circumstances including the height of the user and the nature of the load. The cart can then readily be pulled over the soft surface in the direction shown by arrow A in FIG. 3B. The weight of the cart 30, either unloaded, or partly or fully loaded, will be sufficient to retain a substantial portion of the flexible sheet 1 in a proper position under the wheels 44. However, the guide ribs 10 and 12, or 14 and 16, and the mounting means 18 (FIG. 1) provide an additional protection against undesired lateral movement of the wheels 44 off the flexible sheet 1, particularly in mixed or extremely uneven conditions of snow, mud or sand. When the user reaches the chosen destination, the cart 30 can be returned to the upright position. Either before or after unloading of the cart 30, it can be pushed gently forwards so that the wheels 44 roll off the wheel-supporting surface 2 of the flexible sheet 1, which can be removed, or secured in a non-operational position in the following manner.

Once the cart 30 has been pushed forward sufficiently to release the free edge 24 of the flexible sheet 1, so that it is no longer restrained by the wheels 44, the flexible sheet 1 can be lifted away from the back of the cart 30, by the user holding the sheet at any suitable point, such as free edge 24 or one or both of the side edges 25, and rotating the flexible sheet 1 about the mounting edge 6 which remains secured to the wire framework 34 by the mounting means 18, until the sheet is substantially parallel to the back of the cart 30. It can then be secured into a non-operational position by the secondary securing means such as the clip 28, at the central point 55 on the handle 54, or at one or more securing locations 38 on a horizontal portion of the wire framework 34.

During this lifting and rotation procedure, most of the snow, mud or sand or other substances which may have partly adhered to the lower surface 4 of the flexible sheet 1 will fall to the ground away from the cart 30 as the result of the procedure and the operation of gravity. Any residual substances can readily be shaken off the lower surface 4 as a final step in the procedure, prior to securing the free edge 24 at securing locations 38 or one or both of the side edges 25 to the corner posts 35, thus preventing or reducing the deposit of such substances onto the contents of the cart 30. The flexibility of the sheet increases the effectiveness of this shaking procedure. Preferably the securing locations 38 are situated such that the sheet when secured in the non-operational position will present a slightly concave surface to the framework 34 of the cart 30, which assists in reducing the deposit of substances onto the contents of the cart 30.

The flexible sheet 1 can be retained in this non-operational position for an indefinite time, but it can readily be removed for storage, or for cleaning. The simplicity of the manner of securing of the flexible sheet 1 enables the user to remove it at the entrance to a building, and the configuration of the sheet allows for speedy cleaning, for example by a simple rinsing and air drying.

The manner of securing the flexible sheet 1 to the framework 34 or the corner posts 35 ensures that it will not interfere with the normal opening and closing operation where the cart 30 is provided with the feature of being collapsible by a folding procedure whereby the angle between the base 40 and the back of the cart 30 is substantially reduced, and the front and back of the cart 30 come into substantially closer alignment with each other.

Referring to FIGS. 4A and 4B, a four wheeled cart 31 is shown. Typically the front wheels 50 are smaller than the rear wheels 44, and their axle 48 may be shorter than the rear axle 42. The handle 54 may be attached to the base 40 at any suitable location, but typically is attached at or interconnected with the axle 48 at attachment point 58. In all other respects relating to the purpose and function of the invention, the configuration and function of the cart 31 is substantially similar to the configuration and function of the two-wheeled cart 30.

The flexible sheet 1 for the four-wheeled cart 31 is essentially similar to the sheet provided for the two-wheeled cart 30, but elongated in the direction perpendicular to the mounting edge 6, so that in operation and use it is capable of passing under, being secured in position by, and providing support to, all four wheels, as shown in FIG. 4B. If the axle length of the front axle 48 is shorter than that of the rear axle 42, the inner guide ribs 14, 16 on the flexible sheet 1 can be located so as to assist in retaining the front wheels 50 accurately in position on the sheet.

The flexible sheet 1 is secured to the front of the cart 31 in the same manner as securing is effected for the rear of the cart 30. The free edge 24 thus passes first under the front wheels 50, and as the cart 31 is pushed gently forwards, the smaller front wheels engage the upper wheel supporting surface 2. As the user continues to push the cart gently forward, the larger rear wheels 44 come into contact with the free edge 24, and in turn engage the upper wheel supporting surface 2, guided by the outer guide ribs 10, 12. When both pairs of wheels 44 and 50 of the cart 31 are securely supported by the upper wheel supporting surface 2, the cart 31 can be pushed forward in the direction shown by arrow B in FIG. 4B.

However, if the user wishes to operate the cart 31 by pulling, this can be achieved by the simple operation of removing the flexible sheet 1 from the front of the cart 31 and securing it to the rear of the cart 31, in the same manner as discussed above in relation to the two-wheeled cart 30. To commence movement, the cart 31 is tipped to the desired angle towards the user, and can then be pulled. The flexible sheet 1 will then trail underneath, but not supporting, the front wheels 50, but is sufficiently rigid in the direction of the side edges 25 to remain substantially in place under the cart 31, being maintained in that position by the continuing contact between the rear wheels 44 and the outer ribs 10 and 12 on the upper wheel supporting surface 2.

The procedure for removal or placement in a non-operational position of the flexible sheet 1 from the four-wheeled cart 31 is essentially similar to that for removal from the two-wheeled cart 30. Thus, where the flexible sheet 1 is secured to the front of the cart 31, the cart 31 is gently pulled in the direction of arrow C, until both pairs of wheels 44 and 50 are off the upper wheel supporting surface 2. The mounting means 18 can be released and the flexible sheet 1 can then be removed from the cart 31. If it is desired to retain the flexible sheet secured to the cart 31 in a non-operational position, the free edge 24 can be secured in the same manner as for the two-wheeled cart 30, but preferably to a higher securing location 39 to avoid interference by the flexible sheet 1 with the front wheels 50. Depending on the dimensions of the cart 31, the lower surface 4 of the flexible sheet 1, which will be facing the framework 34 at the front of the cart 31, may present a substantially flat or preferably a slightly concave surface, which will assist in preventing partly adhered substances from falling onto the contents of the cart 31.

If the cart 31 is constructed with the typical feature of being collapsible, it can be folded in the same manner as described above for the two-wheeled cart 30, without any interference from the flexible sheet 1.

The configuration of the flexible sheet has been described primarily in relation to typical utility carts, but can readily be varied to correspond to the varied, often standardized, sizes of other similar conveyances such as utility carts, wagons, walkers, strollers, or recycle bins.

A person understanding the above-described invention may now conceive of alternative designs, using the principles described herein. All such designs which fall within the scope of the claims appended hereto are considered to be part of the present invention.

We claim:

1. An attachment for a multiple-wheeled conveyance, comprising a flexible sheet having a mounting edge, a substantially smooth first surface, an opposing wheel-supporting surface adapted to support at least one axially-connected pair of wheels of said conveyance; and a mounting means for releasably securing said flexible sheet at the mounting edge to said conveyance.

2. An attachment as in claim 1, wherein said flexible sheet is adapted to provide a wheel-supporting surface to two pairs of wheels.

3. An attachment as in claim 1 or 2, wherein said wheel-supporting surface further comprises wheel-guiding means.

4. An attachment as in claim 3, wherein said wheel-guiding means comprises at least one pair of guide ribs substantially perpendicular to said mounting edge of said flexible sheet.

5. An attachment as in claim 4, wherein said wheel-guiding means comprises two parallel pairs of guide ribs each substantially perpendicular to said mounting edge of said flexible sheet.

6. An attachment as in claim 4 or claim 5, wherein said guide ribs are integrally constructed with said flexible sheet.

7. An attachment as in any one of claims 1 to 6, wherein said mounting means is selected from the group comprising hooks, clips, hook and loop fasteners, and buckles.

8. An attachment as in any one of claims 1 to 7, wherein at least one edge opposing or adjacent to said mounting edge is provided with a releasable secondary securing means for selectively and releasably securing the flexible sheet in a non-operational position out of contact with each wheel of the conveyance.

9. An attachment as in claim 8 wherein said secondary securing means is selected from the group consisting of hooks, clips, hook and loop fasteners, buckles.

10. A multiple-wheeled conveyance having attached thereto by a releasably secured mounting means a low-traction attachment comprising a flexible sheet having a mounting edge, a substantially smooth first surface, and an opposing wheel-supporting surface adapted to support at least one axially-connected pair of wheels of said conveyance.

11. A multiple-wheeled conveyance as in claim 10, wherein said wheel-supporting surface further comprises wheel-guiding means.

12. A multiple-wheeled conveyance as in claim 11, wherein said wheel-guiding means comprises at least one pair of guide ribs substantially perpendicular to said mounting edge of said flexible sheet.

13. A multiple-wheeled conveyance as in claim 11, wherein said wheel-guiding means comprises two parallel pairs of guide ribs substantially perpendicular to said mounting edge of said flexible sheet.

14. A multiple-wheeled conveyance as in claim 12 or 13, wherein said guide ribs are integrally constructed with said flexible sheet.

15. A multiple-wheeled conveyance as in claim 10, 11, 12, 13 or 14, wherein said mounting means is selected from the group comprising hooks, clips, hook and loop fasteners, and buckles.

16. A multiple-wheeled conveyance as in claim 10, 11, 12, 13 or 14, wherein at least one edge opposing or adjacent to said mounting edge is provided with a releasable secondary securing means for selectively and releasably securing the flexible sheet in a non-operational position out of contact with each wheel of the conveyance.

17. An attachment as in claim 6 or 14, wherein said flexible sheet is constructed from molded polyethylene.

18. An attachment as in claim 6 or 14, wherein said flexible sheet is constructed from extruded polyethylene.

19. An attachment as in claim 17 or 18, wherein said polyethylene is high-density polyethylene.

20. An attachment as in claim 17 or 18, wherein said polyethylene is hardened polyethylene.

20. An attachment as in claim 6 or 14, wherein said flexible sheet is constructed from molded polypropylene.

21. An attachment as in claim 6 or 14, wherein said flexible sheet is constructed from extruded polypropylene.
